(19) United States
(12) Patent Application Publication
(10) Pub. No.: US 2004/0043506 A1
(43) Pub. Date: Mar. 4, 2004

(54) Cascaded hydrodynamic focusing in microfluidic channels

(76) Inventors: Horst Haussecker, Palo Alto, CA (US); Narayan Sundararajan, San Francisco, CA (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/232,170

(22) Filed: Aug. 30, 2002

(51) Int. Cl. G01N 1/10

(52) U.S. Cl. 436/180; 436/52; 422/100; 422/81

(57) ABSTRACT

Disclosed herein is an apparatus that includes a body structure having a plurality of microfluidic channels fabricated therein, the plurality of microfluidic channels comprising a center channel and focusing channels in fluid communication with the center channel via a plurality of cascaded junctions. Also disclosed herein is a method that includes the step of providing a body structure having a plurality of microfluidic channels fabricated therein, the plurality of microfluidic channels comprising a center channel and focusing channels in fluid communication with the center channel via a plurality of cascaded junctions. The method also includes the steps of providing a flow of the sample fluid within the center channel, providing flows of sheath fluid in the focusing channels, and controlling or focusing the flow of the sample fluid by adjusting the rate at which the sheath fluid flows through the focusing channels and cascaded junctions, and into the center channel. The disclosed apparatus and method can be useful to control or to focus a flow of a sample fluid in a microfluidic process are disclosed. Additionally, the apparatus and method can be useful to detect molecules of interest in a microfluidic process.

### BACKGROUND OF THE DISCLOSURE

1. Field of the Invention

The invention generally relates to fluid transport phenomena and, more specifically, to the control of fluid flow in microfluidic systems and precise localization of particles/molecules within such fluid flows.

2. Brief Description of Related Technology

Miniaturization of a variety of laboratory analyses and functions provides a number of benefits such as, for example, providing substantial savings in time and cost of analyses, and space requirements for the instruments performing the analyses. Such miniaturization can be embodied in microfluidic systems. These systems are useful in chemical and biological research such as, for example, DNA sequencing and immunochromatography techniques, blood analysis, and identification and synthesis of a wide range of chemical and biological species. More specifically, these systems have been used in the separation and transport of biological macromolecules, in the performance of assays (e.g., enzyme assays, immunoassays, receptor binding assays, and other assays in screening for affectors of biochemical systems).

Generally, microfluidic processes and apparatus typically employ microscopic channels through which various fluids are transported. Within these processes and apparatus, the fluids may be mixed with additional fluids, subjected to changes in temperature, pH, and ionic concentration, and separated into constituent elements. Still further, these apparatus and processes also are useful in other technologies, such as, for example, in ink-jet printing technology. The adaptability of microfluidic processes and apparatus can provide additional savings associated with the costs of the human factor of (or error in) performing the same analyses or functions such as, for example, labor costs and the costs associated with error and/or imperfection of human operations.

The ability to carry out these complex analyses and functions can be affected by the rate and efficiency with which these fluids are transported within a microfluidic system. Specifically, the rate at which the fluids flow within these systems affects the parameters upon which the results of the analyses may depend. For example, when a fluid contains molecules, the size and structure of which are to be analyzed, the system should be designed to ensure that the fluid is transporting the subject molecules in an orderly fashion through a detection device at a flowrate such that the device can perform the necessary size and structural analyses. There are a variety of features that can be incorporated into the design of microfluidic systems to ensure the desired flow is achieved. Specifically, fluid can be transported by internal or external pressure sources, such as integrated micropumps, and by use of mechanical valves to re-direct fluids. Utilization of acoustic energy, electrohydrodynamic energy, and other electrical means to effect fluid movement also have been contemplated. Each, however, suffers from certain disadvantages, most notably malfunction. Additionally, the presence of each in a microfluidic system adds to the cost of the system.

Microfluidic systems typically include multiple microfluidic channels interconnected to (and in fluid communication with) one another and to one or more fluid reservoirs. Such systems may be very simple, including only one or two channels and reservoirs, or may be quite complex, including numerous channels and reservoirs. Microfluidic channels generally have at least one internal transverse dimension that is less than about one millimeter (mm), typically ranging from about 0.1 micrometers (μm) to about 500 μm. Axial dimensions of these micro transport channels may reach to 10 centimeters (cm) or more.

Generally, a microfluidic system includes a network of microfluidic channels and reservoirs constructed on a planar substrate by etching, injection molding, embossing, or stamping. Lithographic and chemical etching processes developed by the microelectronics industry are used routinely to fabricate microfluidic apparatus on silicon and glass substrates. Similar etching processes also can be used to construct microfluidic apparatus on various polymeric substrates as well. After construction of the network of microfluidic channels and reservoirs on the planar substrate, the substrate typically is mated with one or more planar sheets that seal channel and reservoir tops and/or bottoms while providing access holes for fluid injection and extraction ports as well as electrical connections, depending upon the end use of the apparatus.

### BRIEF DESCRIPTION OF THE DRAWING FIGURES

For a more complete understanding of the disclosure, reference should be made to the following detailed description and accompanying drawings wherein:

FIG. 1 schematically illustrates a partial cross-section of an enlarged microfluidic apparatus exemplifying single-step (non-cascading), hydrodynamic fluid focusing;

FIG. 2 schematically illustrates a partial cross-section of an enlarged microfluidic apparatus exemplifying multi-step (cascading), hydrodynamic fluid focusing according to the disclosure; and,

FIG. 3 schematically illustrates a partial cross-section of an enlarged microfluidic apparatus exemplifying multi-step (cascading), hydrodynamic fluid focusing according to the disclosure.

While the disclosed method and apparatus are susceptible of embodiments in various forms, there are illustrated in the drawing figures (and will hereafter be described) specific embodiments of the disclosure, with the understanding that the disclosure is intended to be illustrative, and is not intended to limit the invention to the specific embodiments described and illustrated herein.

### DETAILED DESCRIPTION OF THE PREFERRED EMBODIMENTS

As used herein, the term (or prefix) “micro” generally refers to structural elements or features of an apparatus or a component thereof having at least one fabricated dimension in a range of about 0.1 micrometer (μm) to about 500 μm. Thus, for example, an apparatus or process referred to herein as being microfluidic will include at least one structural feature having such a dimension. When used to describe a fluidic element, such as a channel, junction, or reservoir, the term “microfluidic” generally refers to one or more fluidic elements (e.g., channels, junctions, and reservoirs) having at least one internal cross-sectional dimension (e.g., depth, width, length, and diameter), that is less than about 500 μm, and typically between about 0.1 μm and about 500 μm.

The term “hydraulic diameter” as used herein refers to a diameter as defined in Table 5-8 of Perry's Chemical Engineers' Handbook, 6^{th} ed., at p. 5-25 (1984). See also, Perry's Chemical Engineers' Handbook, 7th ed. at pp. 6-12 to 6-13 (1997). Such a definition accounts for channels having a non-circular cross section or for open channels, and also accounts for flow through an annulus.

As known by those skilled in the art, a Reynolds number (N_{Rc}) is any of several dimensionless quantities of the form:

$${N}_{Re} = \frac{l v ρ}{μ} ,$$

which are all proportional to the ratio of inertial force to viscous force in a flow system. Specifically, I is a characteristic linear dimension of the flow channel, ν is the linear velocity, ρ is the fluid density, and μ is the fluid viscosity. Also known by those skilled in the art is the term “streamline,” which defines a line which lies in the direction of flow at every point at a given instant. The term “laminar flow” defines a flow in which the streamlines remain distinct from one another over their entire length. The streamlines need not be straight or the flow steady as long as this criterion is fulfilled. See generally, Perry's Chemical Engineers' Handbook, 6^{th} ed., at p. 5-6 (1984). Generally, where the Reynolds number is less than or equal to 2100, the flow is presumed to be laminar, and where the Reynolds number exceeds 2100, the flow is presumed to be non-laminar (i.e., turbulent). Preferably, the flows of fluid throughout the various microfluidic processes and apparatus herein are laminar.

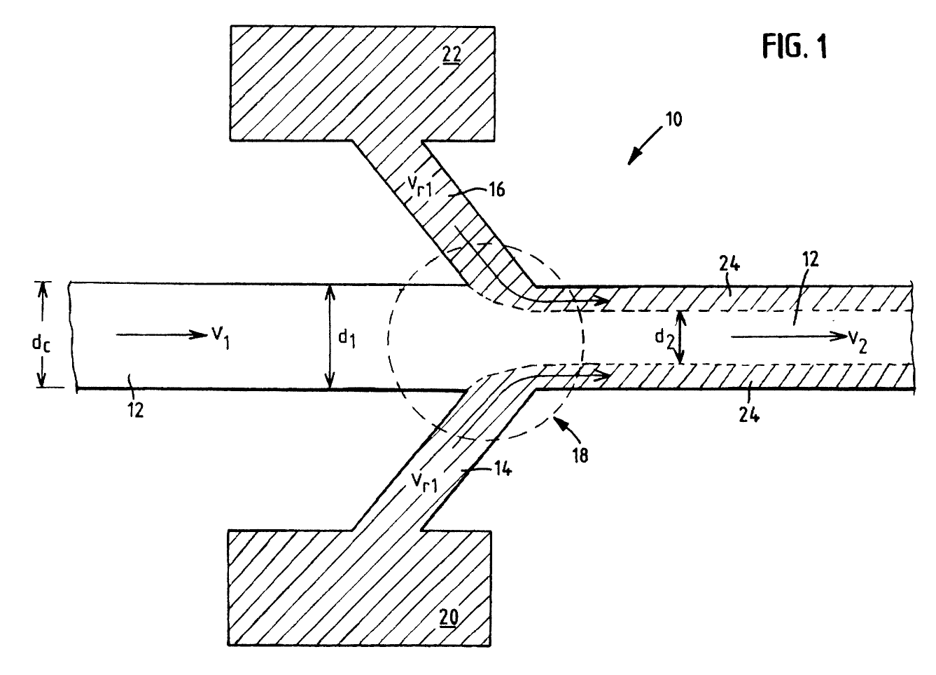

Referring now to the drawing figures wherein like reference numbers represent the same or similar elements in the various figures, FIG. 1 schematically illustrates a partial cross-section of an enlarged microfluidic apparatus exemplifying single-step (non-cascading), hydrodynamic fluid focusing. The apparatus is a body structure 10 having a center channel 12, and symmetric, first and second focusing channels 14 and 16, respectively, in fluid communication with the center channel 12 via a junction 18. As shown in FIG. 1, the first focusing channel 14 is in fluid communication with a first reservoir 20 and the second focusing channel 16 is in fluid communication with a second reservoir 22. Solid arrows indicate the direction of flow through the various channels 12, 14, and 16.

As shown, the center channel 12 has a fixed, inner diameter denoted as d_{c}. Upstream of the junction 18, a sample fluid flows through the center channel 12 at a velocity of vᵢ and occupies a region therein generally having a hydraulic diameter of dᵢ defined by the inner walls of the center channel 12. Upstream of the junction 18, dᵢ is identical to d_{c}. Sheath fluid flows from the first and second reservoirs 20 and 22, respectively, through the first and second focusing channels 14 and 16, respectively, and through the junction 18 at a velocity of vᵣ₁. Because the velocity of the flows of sheath fluid are identical, and depending upon the densities and viscosities of the sheath and sample fluids, the flows of sheath fluid entering the center channel 12 through the junction 18 combine to form a discrete sheath 24 around the flow of sample fluid. The discreteness of the sheath 24 is ensured where, as noted above, the flows of fluid are laminar. Downstream of the junction 18, the sample fluid flows through the center channel 12 at the same flowrate, but a different (and higher) velocity of v₂, and occupies a region therein generally having a hydraulic diameter of d₂. The flows of sheath fluid from the first and second reservoirs 20 and 22, respectively, combine to form the sheath 24 around the sample fluid (an outline of which is depicted by the continuous, dashed streamline within the center channel 12).

Generally, the single-step (non-cascading) hydrodynamic focusing shown in FIG. 1 is accomplished by the three-way junction 18 when sheath fluid from the focusing channels 14 and 16 pushes the sample fluid in the center channel 12 more closer to the center axis of the center channel 12, while increasing the velocity of the sample fluid through the channel 12 from v₁ to v₂. This focusing is represented in FIG. 1 by the continuous, dashed lines within the center channel 12. Any particles (or molecules) suspended in the sample fluid of the center channel 12 upstream of the junction 18, migrate towards the center axis of the channel 12 as the fluid flows through and past the junction 18. Spacial localization of the particles (or molecules) can be controlled and focused in this manner and analyzed or manipulated in downstream operations.

The maximum achievable focusing ratio in a single focusing step is limited by hydrodynamic and geometric constrains that follow an asymptotic relationship. More specifically, the focusing ratio (fₛ) can be expressed by the following equation, where d₁ and d₂ are hydraulic diameters as described above:

$${f}_{s} = \frac{{d}_{1}}{{d}_{2}} .$$

Ideally, a high focusing ratio is desired. For a single focusing step, however, this ratio is subject to limitations, such as those imposed by hydrodynamics effects, pressure gradients, and channel dimensions. For example, as pressure in the focusing channels increases, the flow in the center channel is susceptive to back flow. In other words, depending upon the flow rate in the center channel upstream of the junction, if the flowrate of (or pressure exerted by) the sheath fluid in the focusing channels is too great, the sheath fluid will flow into, not only that portion of the center channel downstream of the junction, but also into portions of the center channel that are upstream of the junction; thus, effectively causing a backwards flow of the sample fluid.

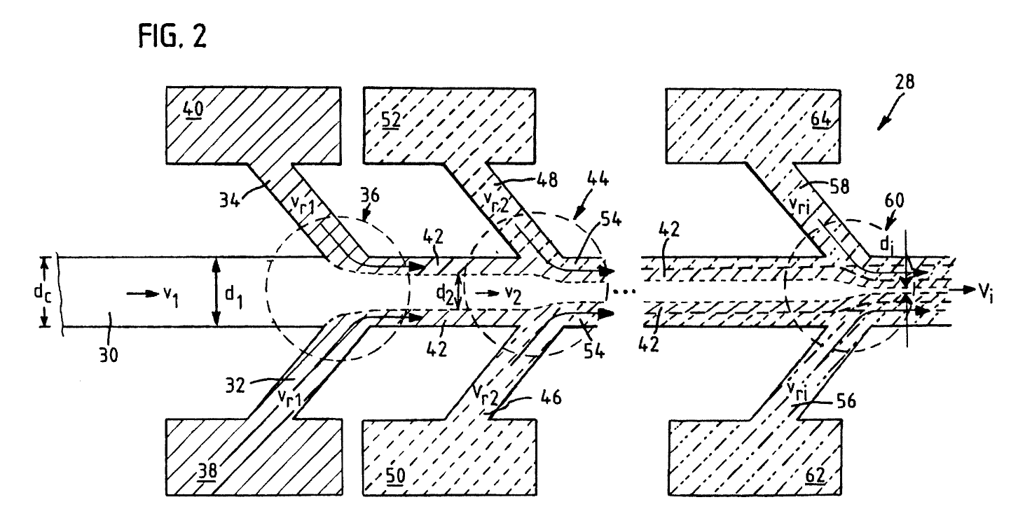

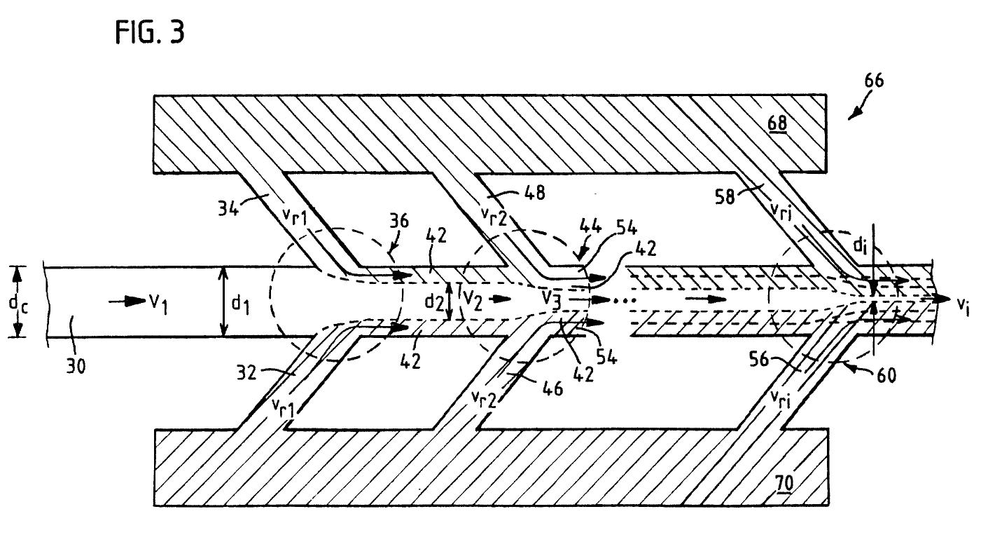

It has been discovered that such limitations can be overcome by utilizing multiple (or multi-step), cascaded junctions whereby the sample fluid is incrementally focused at each successive junction. Specifically, FIGS. 2 and 3 schematically illustrate partial cross-sections of enlarged microfluidic apparatus exemplifying multi-step (cascading), hydrodynamic fluid focusing. Specifically, in FIG. 2, the apparatus is a body structure 28 having a center channel 30, and symmetric, first and second focusing channels 32 and 34, respectively, in fluid communication with the center channel 30 via a first junction 36. As shown in FIG. 2, the first focusing channel 32 is in fluid communication with a first reservoir 38, and the second focusing channel 34 is in fluid communication with a second reservoir 40. Solid arrows indicate the direction of flow through the various channels 30, 32, and 34.

As shown, the center channel 30 has a fixed, inner diameter denoted as d_{c}. Upstream of the junction 36, a sample fluid flows from a reservoir (not shown) and through the center channel 30 at a velocity of v₁ and occupies a region therein generally having a hydraulic diameter of d₁ defined by the inner wall of the center channel 30. Upstream of the junction 36, d₁ is identical to d_{c}. Sheath fluid flows from the reservoirs 38 and 40, through the focusing channels 32 and 34, and through the first junction 36 at a velocity of vᵣ₁. Because the velocity of the flows of sheath fluid are identical, and depending upon the densities and viscosities of the sheath and sample fluids, the flows of sheath fluid entering the center channel 30 through the first junction 36 combine to form a discrete, first sheath 42 around the flow of sample fluid. The discreteness of the first sheath 42 is ensured where, as noted above, the flows of fluid are laminar. Downstream of the first junction 36, the sample fluid flows through the center channel 30 at the same flowrate, but a different (and higher) velocity of v₂, and occupies a region therein generally having a hydraulic diameter of d₂. The flows of sheath fluid from the first and second reservoirs 38 and 40, respectively, combine to form the first sheath 42 around the sample fluid (an outline of which is depicted by the continuous, dashed streamline within the center channel 30).

A second junction 44 downstream (in the direction of flow of the sample fluid in the center channel 30) of the first junction 36 communicates additional sheath fluid from symmetric, third and fourth focusing channels 46 and 48, respectively, into the center channel 30, which already contains the sample fluid surrounded by the first sheath 42. As shown in FIG. 2, the third focusing channel 46 is in fluid communication with a third reservoir 50, and the fourth focusing channel 48 is in fluid communication with a fourth reservoir 52. Solid arrows indicate the direction of flow through the various channels 30, 46, and 48.

Downstream of the first junction 36 and upstream of the second junction 44, the sample fluid flows through the center channel 30 at the same flowrate, but a different (and higher) velocity of v₂, and occupies a region therein generally having a hydraulic diameter of d₂. Sheath fluid flows from the third and fourth reservoirs 50 and 52, respectively, through the third and fourth focusing channels 46 and 48, respectively, and through the second junction 44 at a velocity of vᵣ₂. Because the velocity of the flows of sheath fluid are identical, and depending upon the densities and viscosities of the sheath and sample fluids, the flows of sheath fluid entering the center channel 30 through the second junction 44 combine to form a second, discrete sheath 54 around the flow of the sample fluid and the first sheath 42. The flows of sheath fluid from the third and fourth reservoirs 50 and 52, respectively, combine to form the second sheath 54 around the sample fluid (an outline of which is depicted by the continuous, dashed streamline within the center channel 30).

Together, the first and second junctions 36 and 44, respectively, and the focusing channels (32, 34, 46, and 48) that communicate with the center channel 30 via these junctions encompass an embodiment of a multi-step (cascading), hydrodynamic fluid focusing method and apparatus—specifically two focusing steps or junctions. As shown in FIG. 2, the apparatus can include additional focusing channels 56 and 58 capable of communicating additional sheath fluid via additional junction(s) 60 to the center channel 30. Similarly, these additional focusing channels communicate with additional reservoirs 62 and 64, which can be a source for the additional sheath fluid. To control each focusing step (fₛ), individually, in an apparatus such as the one shown in FIG. 2, the pressure in each reservoir (38, 40, 50, 52, 62, and 64) can be adjusted to yield the desired flow rate of sheath fluid within the communicating channels (32, 34, 46, 48, 56, and 58, respectively).

FIG. 3 schematically illustrates a partial cross-section of an enlarged microfluidic apparatus exemplifying multi-step (cascading), hydrodynamic fluid focusing. Generally, this embodiment is similar to that illustrated in FIG. 2, however, in FIG. 3, the apparatus is a body structure 66 containing focusing channels that draw sheath fluid from fewer (and common) reservoirs 68 and 70. Similar to FIG. 2, however, FIG. 3 also is capable of providing incremental, hydrodynamic fluid focusing. To control each focusing step (fₛ), individually, in an apparatus such as the one shown in FIG. 3, where all (or many) of the focusing channels are communicating with a single reservoir, the dimensions of the individual focusing channels communicating with the single reservoir can be designed to yield the desired flow rate of sheath fluid within those communicating channels.

In an apparatus, such as the ones shown in FIGS. 2 and 3, the total focusing ratio (fₙ) accomplished by n focusing steps (or junctions) can be derived by the following equation, where fᵢ denotes each individual focusing step:

$${f}_{n} = \frac{{d}_{1}}{{d}_{n}} = \frac{{d}_{1}}{{d}_{2}} \frac{{d}_{2}}{{d}_{3}} … \frac{{d}_{( n - 1 )}}{{d}_{n}} = {\prod }_{i = 1}^{n} \frac{{d}_{i}}{{d}_{( i + 1 )}} {\prod }_{i = 1}^{n} {f}_{i} .$$

The focusing ratio of each particular focusing step (fᵢ) can be adjusted by controlling the flow rate of sheath fluid entering the center channel at the corresponding junction. Alternatively, the focusing ratio of each particular focusing step (fᵢ) can be adjusted by controlling the pressure exerted by the sheath fluid on the sample fluid as the sheath fluid enters the center channel at the corresponding junction.

For n focusing steps (or junctions) each communicating with focusing channels having diameters of d_{fci}, connected to a single pair of reservoirs 68 and 70 (see FIG. 3), the foregoing equation reduces to:

fₙ=(fₛ)ⁿ,

which monotonically increases for fₛ>1.

The distances between the successive junctions need not be identical and can be determined by those skilled in the art based upon the intended application. Similarly, the lengths and hydraulic diameters of the various microfluidic channels need not be identical to one another and can be determined based upon the intended application by those skilled in the art.

As a result of the conservation law of laminar flows, the velocity of the sample fluid increases after each successive junction. In order to avoid exceeding the maximum allowable fluid velocity, the apparatus and method should be designed by considering the velocities of the input flow (having a velocity of v₁, as in FIGS. 2 and 3, for example) and focusing flows (having a velocities of vᵣ₁, vᵣ₂, and vᵢ, as in FIGS. 2 and 3, for example). In the situation where a microfluidic system is used for single-molecule detection (e.g., molecules of interest in genomic or DNA sequencing techniques) in a downstream detection device, the foregoing focusing effects can be used to incrementally stretch inter-molecule distances within the sample (molecule-carrying) fluid. Starting with very narrow spacing of adjacent molecules, the molecules can be spaced apart at increasing distances as the sample (molecule-carrying) liquid passes each successive focusing step, to a point where the molecules are sufficiently spaced apart to permit rapid and accurate detection by the detection device. This is but one way in which hydrodynamic focusing using multiple cascaded junctions can be useful in microfluidic systems.

Even though laminar flows of fluid are preferred, as previously noted, diffusional effects may be present even with such laminar flows. Specifically, diffusional effects may be realized as the time period in which a sheath fluid spends in contact with the sample fluid increases. The realized effect can be demonstrated by way of example, wherein a sample fluid contains ten molecules of interest. As this sample fluid flows through the center channel and comes into contact with a sheath fluid, its flow will be controlled (or focused). Though the flows of both fluids may be laminar, as the length of time that the sheath and sample fluid are in contact with one another increases, diffusional forces will cause some of the ten molecules of interest to diffuse from the flow sample fluid into the flow sheath fluid. These diffusional forces may be controlled by, for example, adjusting the fluid flows, adjusting the time period that the sample fluid spends in contact with the sheath fluid, selection of appropriate sheath fluids, and/or adjusting the length of the center channel. In certain applications, the effects of diffusion may be desired (useful), whereas in other applications, such effects may not be desired. For example, these diffusional effects may be useful to obtain a fluid detection volume where only a single molecule of interest resides.

The hydraulic diameter of each of the microfluidic channels preferably is about 0.01 μm to about 500 μm, highly preferably about 0.1 μm and 200 μm, more highly preferably about 1 μm to about 100 μm, even more highly preferably about 5 μm to about 20 μm. The various focusing channels (32, 34, 46, 48, 56, and 58) can have the same or different hydraulic diameters. Preferably, symmetric focusing channels have equal or substantially equal size hydraulic diameters. Depending upon the particular application, the various focusing channels may have hydraulic diameters that are less than (or greater than) the hydraulic diameter of the center channel.

Generally, the sheath fluid flows through the focusing channels and cascaded junctions at different flowrates relative to each other. However, preferably, the flows of fluid through symmetric focusing channels are equal or substantially equal. Furthermore, the sheath fluid can flow through the respective focusing channels and respective cascaded junctions at a flowrate greater than the rate at which fluid flows through the center channel immediately upstream of the respective junctions.

The body structure of the microfluidic apparatus and method described herein typically includes an aggregation of two or more separate substrates, which, when appropriately mated or joined together, form the desired microfluidic device, e.g., containing the channels and/or chambers described herein. Typically, the microfluidic apparatus described herein can include top and bottom substrate portions, and an interior portion, wherein the interior portion substantially defines the channels, junctions, and reservoirs of the apparatus.

Suitable substrate materials include, but are not limited to, an elastomer, glass, a silicon-based material, quartz, fused silica, sapphire, polymeric material, and mixtures thereof. The polymeric material may be a polymer or copolymer including, but not limited to, polymethylmethacrylate (PMMA), polycarbonate, polytetrafluoroethylene (e.g., TEFLON™), polyvinylchloride (PVC), polydimethylsiloxane (PDMS), polysulfone, and mixtures thereto. Such polymeric substrate materials are preferred for their ease of manufacture, low cost, and disposability, as well as their general inertness. Such substrates are readily manufactured using available microfabrication techniques and molding techniques, such as injection molding, embossing or stamping, or by polymerizing a polymeric precursor material within the mold. The surfaces of the substrate may be treated with materials commonly used in microfluidic apparatus by those of skill in the art to enhance various flow characteristics.

Use of a plurality of cascaded junctions in the manner described herein results in microfluidic flow systems that do not need conventional flow control equipment, like internal or external pressure sources, such as integrated micropumps, or mechanical valves to re-direct the fluids. Utilization of acoustic energy, electrohydrodynamic energy, and other electrical means to effect fluid movement also are not necessary when employing the plurality of cascaded junctions in the manner described herein. Without conventional equipment, there is less likelihood of system malfunction and total costs associated with the operation and manufacture of such systems.

The microfluidic processes and apparatus described herein can be used as a part of a larger microfluidic system, such as in conjunction with instrumentation for monitoring fluid transport, detection instrumentation for detecting or sensing results of the operations performed by the system, processors, e.g., computers, for instructing the monitoring instrumentation in accordance with preprogrammed instructions, receiving data from the detection instrumentation, and for analyzing, storing and interpreting the data, and providing the data and interpretations in a readily accessible reporting format.

The foregoing description is given for clearness of understanding only, and no unnecessary limitations should be understood therefrom, as modifications within the scope of the disclosure may be apparent to those having ordinary skill in the art.

What is claimed is:

1. An apparatus useful to control or to focus a flow of a sample fluid in a microfluidic process, the apparatus comprising a body structure having a plurality of microfluidic channels fabricated therein, the plurality of microfluidic channels comprising a center channel and focusing channels in fluid communication with the center channel via a plurality of cascaded junctions.

2. The apparatus of claim 1, wherein the center channel is in fluid communication with a reservoir containing the sample fluid.

3. The apparatus of claim 1, wherein the focusing channels are in fluid communication with one or more reservoirs, each reservoir containing a sheath fluid.

4. The apparatus of claim 1, wherein the body structure is a material selected from the group consisting of an elastomer, glass, a silicon-based material, quartz, fused silica, sapphire, polymeric material, and mixtures thereof.

5. The apparatus of claim 4, wherein the polymeric material is a polymer or copolymer selected from the group consisting of polymethylmethacrylate, polycarbonate, polytetrafluoroethylene, polyvinylchloride, polydimethylsiloxane, polysulfone, and mixtures thereof.

6. The apparatus of claim 1, wherein each of the microfluidic channels has a hydraulic diameter and the hydraulic diameters of the focusing channels are all equal.

7. The apparatus of claim 1, wherein each of the microfluidic channels has a hydraulic diameter and the hydraulic diameter of each of the focusing channels is less than the hydraulic diameter of the center channel.

8. The apparatus of claim 1, wherein each of the microfluidic channels has a hydraulic diameter and the hydraulic diameter of each of the focusing channels is greater than the hydraulic diameter of the center channel.

9. The apparatus of claim 1, wherein each of the microfluidic channels has a hydraulic diameter of about 0.01 micrometers (μm) to about 500 μm.

10. The apparatus of claim 9, wherein the hydraulic diameter is about 0.1 μm and 200 μm.

11. The apparatus of claim 10, wherein the hydraulic diameter is about 1 μm to about 100 μm.

12. The apparatus of claim 11, wherein the hydraulic diameter is about 5 μm to about 20 μm.

13. A method useful to control or to focus a flow of a sample fluid in a microfluidic process, the method comprising the steps of:
(a) providing a body structure having a plurality of microfluidic channels fabricated therein, the plurality of microfluidic channels comprising a center channel and focusing channels in fluid communication with the center channel via a plurality of cascaded junctions;
(b) providing a flow of the sample fluid within the center channel;
(c) providing flows of sheath fluid in the focusing channels; and,
(d) controlling or focusing the flow of the sample fluid by adjusting the rate at which the sheath fluid flows through the focusing channels and cascaded junctions, and into the center channel.

14. The method of claim 13, wherein the flow of sample fluid is laminar.

15. The method of claim 13, wherein the flows of sheath fluid are laminar.

16. The method of claim 13, wherein sheath fluid flows through the focusing channels and cascaded junctions at different flowrates relative to each other.

17. The method of claim 13, wherein the sheath fluid flows through the respective focusing channels and respective cascaded junctions at a flowrate greater than the rate at which fluid flows through the center channel immediately upstream of the respective junctions.

18. A method useful to detect molecules in a microfluidic process, the method comprising the steps of:
(a) providing a body structure having a plurality of microfluidic channels fabricated therein, the plurality of microfluidic channels comprising a center channel and focusing channels in fluid communication with the center channel via a plurality of cascaded junctions;
(b) providing a flow of the sample fluid within the center channel, the sample fluid containing molecules of interest spaced apart from one another by a distance;
(c) providing flows of sheath fluid in the focusing channels;
(d) controlling or focusing the flow of the sample fluid by adjusting the rate at which the sheath fluid flows through the focusing channels and cascaded junctions, and into the center channel;
(e) increasing the distance between the molecules within the sample fluid to permit single molecule detection in a detection device; and,
(f) detecting the molecules in the detection device.

19. The method of claim 18, wherein the flow of sample fluid is laminar.

20. The method of claim 18, wherein the flow of sheath fluid is laminar.

21. An apparatus comprising a body structure having a plurality of microfluidic channels fabricated therein, the plurality of microfluidic channels comprising a center channel and focusing channels in fluid communication with the center channel via a plurality of cascaded junctions.

22. The apparatus of claim 21, wherein the center channel is in fluid communication with a reservoir containing a sample fluid.

23. The apparatus of claim 21, wherein the focusing channels are in fluid communication with one or more reservoirs, each reservoir containing a sheath fluid.

24. The apparatus of claim 21, wherein the body structure is a material selected from the group consisting of an elastomer, glass, a silicon-based material, quartz, fused silica, sapphire, polymeric material, and mixtures thereof.

25. The apparatus of claim 24, wherein the polymeric material is a polymer or copolymer selected from the group consisting of polymethylmethacrylate, polycarbonate, polytetrafluoroethylene, polyvinylchloride, polydimethylsiloxane, polysulfone, and mixtures thereof.

26. The apparatus of claim 21, wherein each of the microfluidic channels has a hydraulic diameter and the hydraulic diameters of the focusing channels are all equal.

27. The apparatus of claim 21, wherein each of the microfluidic channels has a hydraulic diameter and the hydraulic diameter of each of the focusing channels is less than the hydraulic diameter of the center channel.

28. The apparatus of claim 21, wherein each of the microfluidic channels has a hydraulic diameter and the hydraulic diameter of each of the focusing channels is greater than the hydraulic diameter of the center channel.

29. The apparatus of claim 21, wherein each of the microfluidic channels has a hydraulic diameter of about 0.01 micrometers (μm) to about 500 μm.

30. The apparatus of claim 29, wherein the hydraulic diameter is about 0.1 μm and 200 μm.

31. The apparatus of claim 30, wherein the hydraulic diameter is about 1 μm to about 100 μm.

32. The apparatus of claim 31, wherein the hydraulic diameter is about 5 μm to about 20 μm.

33. A method comprising the steps of:
(a) providing a body structure having a plurality of microfluidic channels fabricated therein, the plurality of microfluidic channels comprising a center channel and focusing channels in fluid communication with the center channel via a plurality of cascaded junctions;
(b) providing a flow of a sample fluid within the center channel;
(c) providing flows of sheath fluid in the focusing channels; and,
(d) controlling or focusing the flow of the sample fluid by adjusting the rate at which the sheath fluid flows through the focusing channels and cascaded junctions, and into the center channel.

34. The method of claim 33, wherein the flow of sample fluid is laminar.

35. The method of claim 33, wherein the flows of sheath fluid are laminar.

36. The method of claim 33, wherein sheath fluid flows through the focusing channels and cascaded junctions at different flowrates relative to each other.

37. The method of claim 33, wherein the sheath fluid flows through the respective focusing channels and respective cascaded junctions at a flowrate greater than the rate at which fluid flows through the center channel immediately upstream of the respective junctions.

38. A method comprising the steps of:
(a) providing a body structure having a plurality of microfluidic channels fabricated therein, the plurality of microfluidic channels comprising a center channel and focusing channels in fluid communication with the center channel via a plurality of cascaded junctions;
(b) providing a flow of the sample fluid within the center channel, the sample fluid containing molecules of interest spaced apart from one another by a distance;
(c) providing flows of sheath fluid in the focusing channels;
(d) controlling or focusing the flow of the sample fluid by adjusting the rate at which the sheath fluid flows through the focusing channels and cascaded junctions, and into the center channel;
(e) increasing the distance between the molecules within the sample fluid to permit single molecule detection in a detection device; and,
(f) detecting the molecules in the detection device.

39. The method of claim 38, wherein the flow of sample fluid is laminar.

40. The method of claim 38, wherein the flow of sheath fluid is laminar.
